(19) United States
(12) Patent Application Publication
(10) Pub. No.: US 2008/0193895 A1
(43) Pub. Date: Aug. 14, 2008

(54) Wireless Recharger For Back Filler On Endodontic Treatment

(75) Inventors: In-Whan Lee, Seoul (KR); Cheol-Su Kim, Incheon (KR); Seung-Ho Baek, Seoul (KR)

Correspondence Address: MARSH, FISCHMANN & BREYFOGLE LLP, 3151 SOUTH VAUGHN WAY, SUITE 411, AURORA, CO, 80014, US

(73) Assignee: B & L BIOTECH CO., LTD., Gunpo-si, Gyeonggi-do (KR)

(21) Appl. No.: 11/909,937

(22) PCT Filed: Feb. 27, 2006
(86) PCT No.: PCT/KR2006/000677

§ 371 Date: Jan. 18, 2008

(30) Foreign Application Priority Data
Mar. 28, 2005 (KR) 10-2005-0025676

(51) Int. Cl. A61C 5/04

(52) U.S. Cl. 433/32

(57) ABSTRACT

A cordless endodontic filling instrument for back [symbol] filling is disclosed which uses a switching circuit enabling the filling instrument to be operable using a small dry battery for supply DC power, and enabling the filling instrument to sense variation in capacitance and to control operation of heating wire based on the sensed capacitance variation. The filling instrument includes a body having a pen shape to enable an operator to easily grasp the body, includes a DC power source and a main printed circuit board arranged in the body, a heat generating tip extending forwardly from the body and heating and melting gutta-percha to fill a root canal with the melted gutta-percha, and a touch switch arranged at a front portion of the body to sense variation in capacitance occurring when the operator touches the touch switch, and to turn on the heat generating tip based on the sensed capacitance variation.

### TECHNICAL FIELD

The present invention relates to a filling instrument for filling gutta-percha, which is root canal filling gum, in a root canal in a dental treatment, and more particularly, to a complete melting type cordless gutta-percha filling instrument which uses a switching circuit, to efficiently generate heat from a heating coil using a miniature battery without supply of external electric power, and uses a cordless type handpiece, to enable the filling instrument to be conveniently used.

### BACKGROUND ART

In a decayed tooth treating method, which is generally used in a dental clinic, a decayed portion of a tooth is first removed using an endodontic file. When the pulp of the tooth is injured, the injured or affected pulp is also removed. Thereafter, a filler, which is endodontic cement or a sealer, is filled in a portion of the tooth to be treated, namely, the root canal of the tooth, to seal the root canal. Finally, a prosthetic treatment is carried out on the tooth. In the root canal filling procedure, gutta-percha cones are used as a temporary filling material having an auxiliary function for enabling the filler to penetrate into the root canal and thus to seal up the root canal. Gutta-percha, which is a natural vegetable extract, has a semisolid phase at room temperature, but has the form of a solid gum when it is compressed or heated. The gutta-percha having the form of such a solid gum is called “white gutta-percha”.

Generally, gutta-percha cones are prepared by adding zinc oxide, barium sulfate, wax, and pigment to gutta-percha, kneading them into a paste in a mixer, extruding the paste in the form of a sheet using rolls, cutting the sheet into pieces, and shaping the pieces into a conical structure. Thus, gutta-percha cones having various sizes can be formed. The gutta-percha cone is widely used as a material for endodontic treatment because it is known as most biologically compatible with living bodies and it is harmless to the root apexes of teeth. Gutta-percha cones, which are currently commercially available, are classified into a standardized cone and an accessory cone. The standardized cone has a shape identical to that of a dental file.

In endodontic treatment for a decayed tooth, the affected pulp of the tooth is first drilled to remove affected nerve tissues. Thereafter, a filler is coated on the root canal wall in order to prevent the root canal from being further affected by a source of decay. A gutta-percha cone having a suitable size is then inserted into the root canal to fix the filler to the main and accessory portions of the root canal. In this case, it is important to bring the gutta-percha cone into complete contact with the root canal wall and apical area of the tooth.

After completion of the root canal filling procedure, the filling state in the root canal is confirmed using X-ray photography. The gutta-percha cone is then removed. For the removal of the gutta-percha cone, an excavator, an endodontic plugger, or a spreader is used in a state of being heated in flame.

The present invention relates to a gutta-percha filling instrument which applies a gutta-percha cone to a root canal wall in a dental clinic procedure, as mentioned above, such that the gutta-percha cone comes into complete contact with the root canal wall. In particular, the present invention relates to a filling instrument for back-filling about a ⅓ part of a root canal which fills a root canal with gutta-percha while melting the gutta-percha using a Buchanan plugger to achieve back-filling of the root canal. This may be explained in conjunction with System B manufactured by Analytic Company. For endodontic treatment, a method for filling a root canal with gutta-percha is generally used which is carried out by filling about a ⅓ part of the root canal using a filling instrument for back-filling such as System B manufactured by Analytic Company, and then filling the remaining part of the root canal using a complete melting type filling instrument such as Obtura II manufactured by Obtura Spartan Company.

Generally, the endodontic filling instrument for back-filling includes a handpiece, and a control box which includes a power source for supplying electric power to the handpiece, and a controller for controlling the handpiece. The handpiece, which is grasped by a doctor for endodontic treatment, is separate from the control box and it is electrically connected with the control box by a cable.

Hereinafter, a conventional filling instrument for endodontic treatment will be described with reference to FIGS. 1 and 2.

FIG. 1 is a view illustrating an example of a configuration of a conventional filling instrument for endodontic treatment. FIG. 2 is a schematic view illustrating a configuration of a touch sensor for turning on a heating coil included in the conventional filling instrument for endodontic treatment.

As shown in FIGS. 1 and 2, the conventional endodontic filling instrument includes a control box 10 which includes a control panel 11, a display (not shown) for displaying an operation state of the filling instrument, and a power switch 12. The conventional endodontic filling instrument also includes a handpiece 20 which includes a spreader 21 including a heating wire for supplying heat to gutta-percha to melt or cut the gutta-percha, and a touch switch 22 adapted to turn on the heating wire of the spreader 21 when the user touches the touch switch 22.

The control box 10 and handpiece 20 are connected to each other by a cable 30. Electric power required by the handpiece 20 is supplied from the control box 10 via the cable 30.

The touch switch 22 of the handpiece 20 is configured to turn on the heating wire of the spreader 21 when the touch switch 22 is touched by the finger of the user. For example, as shown in FIG. 2, the touch switch 22 includes a rod-shaped connecting terminal 23, and a switch 24 having a coil spring shape. When the user presses the spring-shaped switch 24, the switch 24 is deformed so that it is connected to the connecting terminal 23. Accordingly, the heating wire of the spreader 21 is turned on. When the user releases the finger from the switch 24, the switch 24 returns to an original position by virtue of the elasticity thereof. Accordingly, the heating wire of the spreader 21 is turned off.

However, the above-mentioned conventional filling instrument has a problem in that, when the spring-shaped switch 24 is positioned to be inclined, it may malfunction due to gravity acting thereupon.

The conventional filling instrument also has a problem that there is inconvenience in carrying the filling instrument because the control box and handpiece are separate from each other.

### DISCLOSURE

### Technical Problem

Therefore, the present invention has been made in view of the above problems, and it is an object of the present invention to provide a cordless endodontic filling instrument for back-filling which uses a switching circuit enabling the filling instrument to be operable using a miniature dry battery adapted to supply DC power, and enabling the filling instrument to sense a variation in capacitance, and thus, to control operation of a heating wire, based on the sensed capacitance variation.

### Technical Solution

In accordance with an aspect of the present invention, the above and other objects can be accomplished by the provision of a cordless endodontic filling instrument for back-filling comprising: a body which has a pen shape, to enable an operator to easily grasp the body, includes a DC power source and a main printed circuit board which are arranged in the body; a heat generating tip which extends forwardly from the body, and functions to heat and melt gutta-percha, and to fill a root canal with the melted gutta-percha; and a touch switch which is arranged at a front portion of the body, to sense a variation in capacitance occurring when the operator touches the touch switch by the finger, and to turn on the heat generating tip based on the sensed capacitance variation.

The body may further include an operation condition setting button for setting an operation condition of the filling instrument, and a display for displaying an operation state of the filling instrument.

The body may further include a light emitter arranged at a front end portion of the body, to illuminate an oral cavity. The light emitter may include a light emitting diode (LED).

The heat generating tip may include a heat generating core which is arranged in an interior of the heat generating tip, an insulating film which encloses the heat generating core, and a conical resistant heat generating layer which encloses the insulating film, and has a cross-sectional area gradually reduced toward a front end of the heat generating core. The front end of the heat generating core may be connected to the resistant heat generating layer.

The touch switch may include a high-frequency generator, a resistor connected to the high-frequency generator, and a touch plate arranged to enclose a front end portion of the body where the finger of the operator will be positioned when the operator grasps the filling instrument.

The switching circuit may be a synchronous type buck converter switching circuit which includes two switches controlled to be alternately opened and closed, and an inductor and a resistor which are connected to one of the switches in series. The resistor of the switching circuit may be the heat generating tip.

The inductor of the switching circuit may be arranged in a front end portion of the body near the heat generating tip.

The DC power source of the body may include a rechargeable battery such that the DC power source is rechargeable after an operation.

### ADVANTAGEOUS EFFECTS

In accordance with the present invention, although the filling instrument of the present invention is of a cordless type, it is possible to perform an operation for a lengthened period of time using the cordless filling instrument because the filling instrument uses the switching circuit capable of enabling the DC power source to operate very efficiently, and thus, to activate the heat generating tip.

In accordance with the present invention, it is possible to prevent malfunction of the filling instrument caused by a physical deformation of the touch switch because the filling instrument is turned on in accordance with operation of the touch sensor adapted to sense a variation in capacitance. It is also possible to generate heat from the heat generating tip at a position and a point of time desired by the operator.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating an example of a configuration of a conventional complete melting type filling instrument for endodontic treatment;

FIGS. 2 and 3 are schematic views illustrating a configuration of a touch sensor for turning on a heating coil included in the conventional filling instrument for endodontic treatment;

FIG. 4 is a side view illustrating a cordless endodontic filling instrument for back-filling according to an exemplary embodiment of the present invention;

FIG. 5 is a sectional view illustrating a heat generating tip included in the cordless endodontic filling instrument for back-filling according to the present invention;

FIG. 6 is a sectional view schematically illustrating another embodiment of the heat generating tip shown in FIG. 5;

FIG. 7 is a circuit diagram illustrating a touch switch for turning on the heat generating tip in accordance with the present invention;

FIG. 8 is a side view of an inner structure of the filling instrument, illustrating a mounting state of the touch switch;

FIG. 9 is a circuit diagram illustrating a switching circuit for maximizing the efficiency of a DC power source included in the cordless endodontic filling instrument for back-filling in accordance with the present invention;

FIG. 10 is a graph depicting the relation between the current consumed by the switching circuit of FIG. 9 and the temperature of a heat generating element; and

FIG. 11 is a block diagram illustrating operation of the cordless endodontic filling instrument for back-filling according to the present invention.

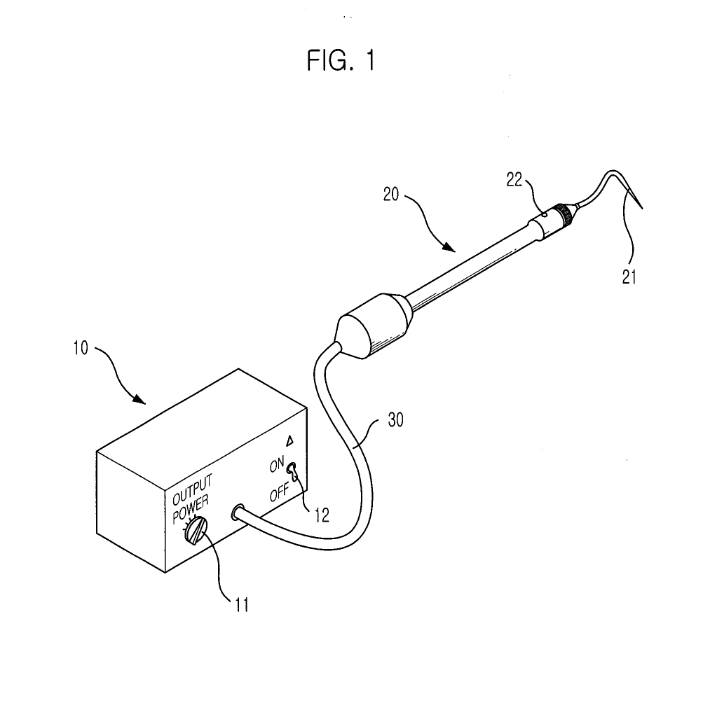

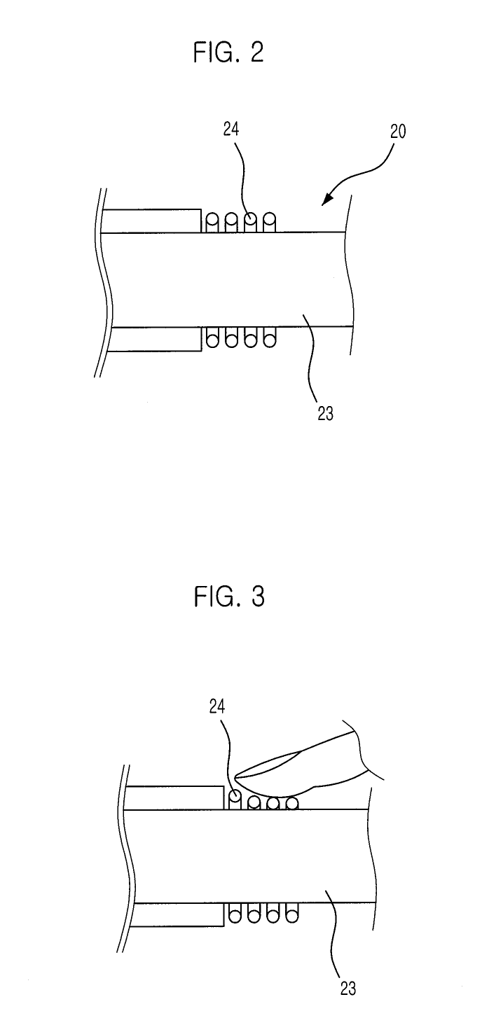

### BEST MODE

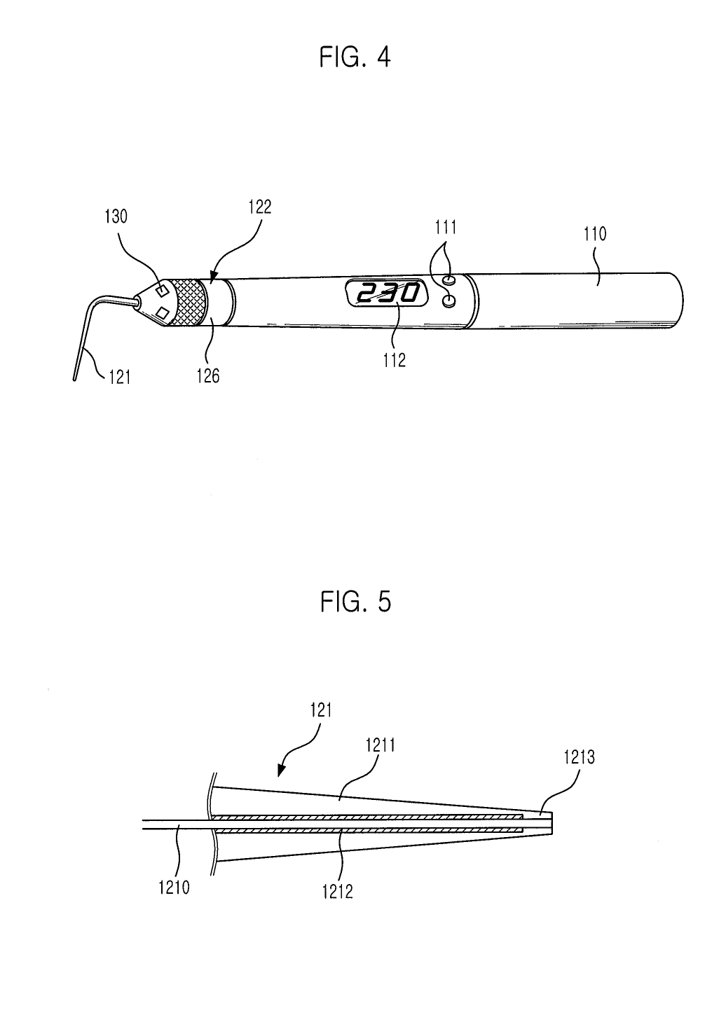

Hereinafter, a cordless endodontic filling instrument for back-filling according to an exemplary embodiment of the present invention will be described with reference to FIGS. 4 to 10.

FIG. 4 is a side view illustrating a cordless endodontic filling instrument for back-filling according to an exemplary embodiment of the present invention. FIG. 5 is a sectional view illustrating a heat generating tip included in the cordless endodontic filling instrument for back-filling according to the present invention.

As shown in FIG. 4, the cordless endodontic filling instrument for back-filling according to the illustrated embodiment includes a body 110 which has a pen shape, to enable the user to easily grip the body 110, and in which a DC power source 101 and a main printed circuit board are arranged, and a heat generating tip 121 which extends forwardly from the body 110, and generates heat, to melt gutta-percha disposed at a desired position, and thus, to fill a root canal with the melted gutta-percha. The filling instrument also includes an operation condition setting button 111 which is arranged at a central portion of the body 110, to set a temperature of the heat generating tip 121 and a desired operation condition of the filling instrument, and a display 112 which is adapted to display an operation state of the heat generating tip 121. The filling instrument further includes a touch switch 122 which is arranged at a front portion of the body 110, to sense a variation in capacitance occurring when the user touches the touch switch 122, and thus, to turn on the heat generating tip 121.

A light emitter 130 may be installed on a front end portion of the body 110, to illuminate an affected part to be treated.

As shown in FIG. 5, the heat generating tip 121 includes a heat generating core 1210, an insulating film 1212 which covers the heat generating core 1210, and a resistant heat generating layer 1211 which has a conical shape having a cross-sectional area gradually reduced toward a front end 1213 of the heat generating core 1210. The insulating film 1212 does not cover the front end 1213 of the heat generating core 1210 such that the front end 1213 of the heat generating core 1210 is connected to the resistant heat generating layer 1211. Accordingly, when current flows through the resistant heat generating layer 1211 and heat generating core 1210, increased current density is exhibited at the end 1213 where the heat generating core 1210 and resistant heat generating layer 1211 are connected. As a result, a largest amount of heat is generated at the end 1213.

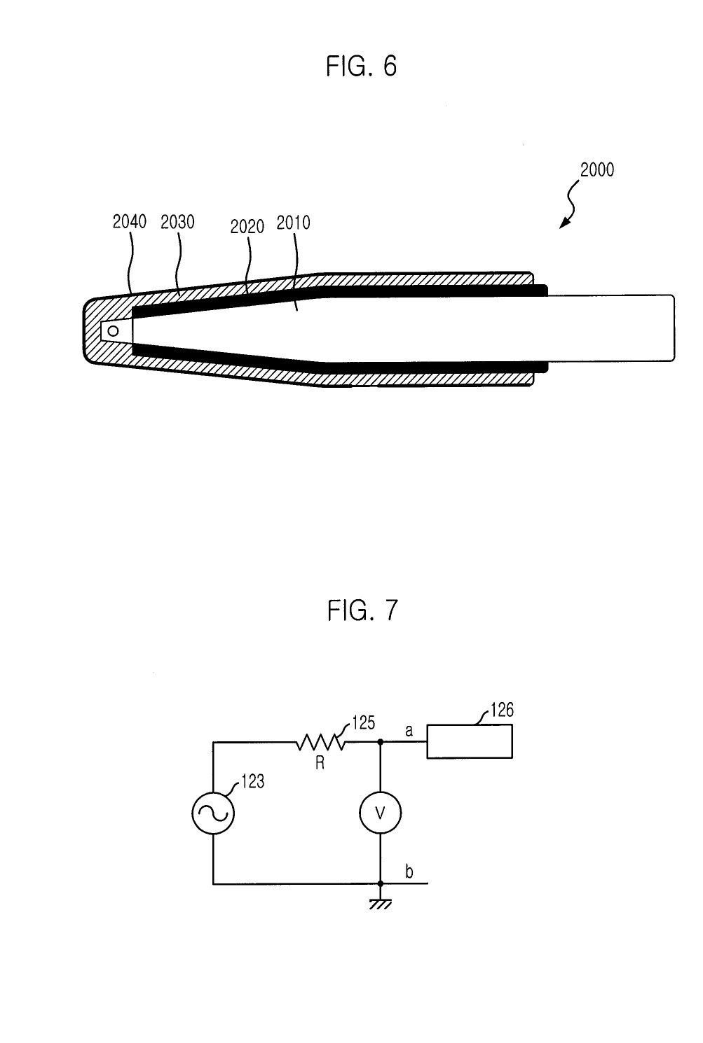

FIG. 6 is a sectional view schematically illustrating another embodiment of the heat generating tip shown in FIG. 5. In this case, the heat generating tip 2000 includes a heat generating core 2010, an insulator 2020, and a resistant heat generating layer 2030. The heat generating core 2010 is made of aluminum or aluminum alloy which exhibits excellent workability, as compared to copper. For the aluminum alloy, Duralumin may be used. Preferably, the heat generating core 2010 is made up of a hollow pipe.

The insulator 2020 is made of alumite. The insulator 2020 covers the heat generating core 2010, except for a front end of the heat generating core 2010. Tin is sputtered over the outer surface of the resistant heat generating layer 2030. Nickel is also sputtered on the lower surface of the resistant heat generating layer 2030 at a predetermined region. In accordance with the sputtering of nickel, a nickel film 2050 is formed. Since the nickel film 2050 has a high temperature coefficient of resistance of 6×10⁻³, it is possible to perform precise temperature sensing. In accordance with the sputtering of tin, a tin film 2040 is formed. The tin film 2040 prevents the nickel film 2050, which is harmful to living bodies, from being outwardly exposed, and thus, secures a safe operation.

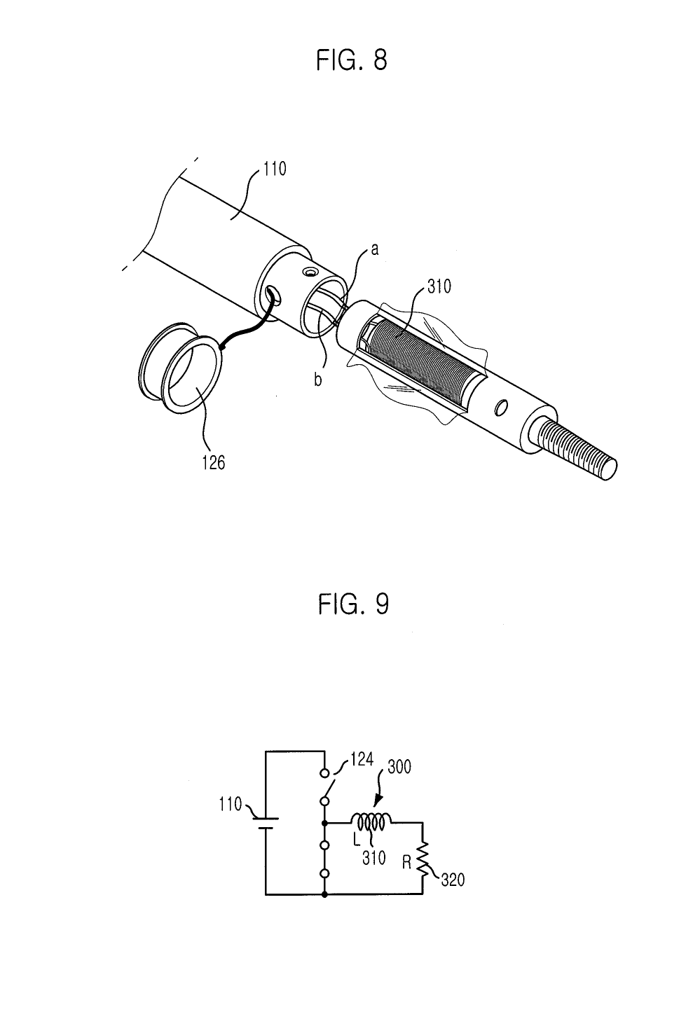

FIG. 7 is a circuit diagram illustrating a touch sensor for turning on the heat generating tip in accordance with the present invention. FIG. 8 is a side view of an inner structure of the filling instrument, illustrating a mounting state of the touch sensor.

As shown in FIGS. 7 and 8, the touch switch 122 includes a high-frequency generator 124, a resistor 125 connected to the high-frequency generator 124, and a touch plate 126 connected to the resistor 125, and arranged to enclose the outer surface of the front end portion of the body 110 where the finger of the user will be positioned when the user grasps the filling instrument.

The body 110 functions as a grounding part. Accordingly, when the user touches the touch plate 126 by the finger, the resistor 125 is connected to the body 110 via the finger. Accordingly, the impedance generated in a region a-b between the resistor 125 and the body 110 is reduced, thereby causing a variation in voltage, namely, a variation in capacitance. Thus, it is possible to determine whether or not the finger touches the touch plate 126, by sensing the capacitance variation. When the finger touches the touch plate 126, the heat generating tip 121 is turned on. This switch structure can reduce malfunction caused by the posture of the instrument, as compared to the conventional spring type switch. The sensing of the capacitance variation can be achieved by measuring a voltage V across the region a-b. The reason why high-frequency waves are used is to enable the touch sensor to sense a fine variation in capacitance even when the operator wears a material, through which a relatively limited amount of current flows, for example, operating groves.

FIG. 9 is a circuit diagram illustrating a switching circuit for maximizing the efficiency of the DC power source included in the cordless endodontic filling instrument for back-filling in accordance with the present invention.

As shown in FIG. 9, in the illustrated embodiment, a synchronous type buck converter 300 is used to implement the cordless instrument using the DC power source. That is, the buck converter 300 includes two switches 301 and 302 which are controlled to be alternately opened and closed. An inductor 310 and a resistor 320 are connected to the switches 301 and 302 in series.

The resistor 320 may be used as the resistance of the heat generating element. The resistor 320 has a very low resistance of 0.05 to 0.1Ω.

The DC power source of the body is constituted by a rechargeable battery. Accordingly, it is unnecessary to replace the DC power source with a new one during an operation because the DC power source is rechargeable. It is also possible to reduce the consumption of batteries.

Meanwhile, when the inductor 310 of the switching circuit is arranged near the front end of the body 110, namely, the heat generating tip 121, it is possible to reduce loss of electric power, and thus, to achieve a high efficiency.

Hereinafter, operation of the cordless endodontic filling instrument for back-filling according to the present invention, and functions and effects thereof will be described with reference to FIGS. 9 to 11.

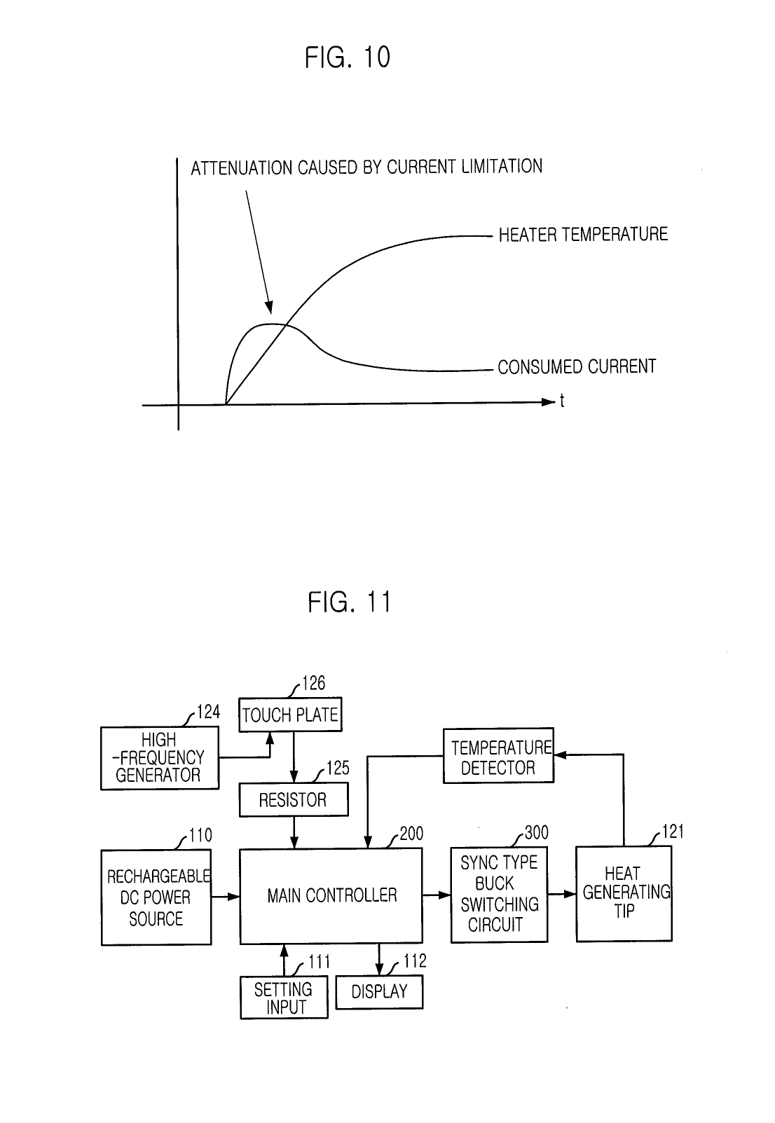

As described above, FIG. 9 is a circuit diagram illustrating the switching circuit which maximizes the efficiency of the DC power source included in the cordless endodontic filling instrument for back-filling in accordance with the present invention. FIG. 10 is a graph depicting the relation between the current consumed by the switching circuit of FIG. 9 and the temperature of the heat generating element. FIG. 11 is a block diagram illustrating operation of the cordless endodontic filling instrument for back-filling according to the present invention.

Referring to FIGS. 9 and 10, it can be seen that it is possible to accumulate energy by controlling the time for which current flows, namely, current limiting time, using the switching circuit of the present invention. This is because electrical energy is accumulated in the inductor of the switching circuit. Accordingly, an increase in the efficiency of the battery, and thus, an increase in the use time of the battery, can be achieved.

When the heat generating tip of the heater is directly connected to a power source having a certain voltage without using the switching circuit, a great increase in current occurs because the resistance of the heat generating tip is very small. For this reason, the current flowing through the heater may be larger than allowable current. As the current increases, degradation in efficiency and an increase in consumption of power occur. As a result, the usable time of the battery is reduced.

It was experimentally confirmed that, when a 3.7 V DC power source having an internal resistance of 0.08Ω is directly connected to a heat generating tip of 0.05Ω, current of about 28 A flows. In this case, it was also confirmed that the use time of the battery is about 4 minutes which is very short, and the temperature of the heat generating tip increases continuously. However, when a switching circuit using a synchronous type buck converter was used, as in the present invention, current was reduced, and was maintained at about 1.7 A, even through consumption of initial current was large, as shown in the graph of FIG. 10. As a result, the continuous use time of the battery was one hour or more. Also, the temperature of the heat generating tip was maintained constant.

As apparent from the above description, in accordance with the present invention, a cordless gutta-percha filling instrument for endodontic treatment capable of using a miniature battery can be manufactured using a switching circuit which realizes a high efficiency.

As shown in FIG. 11, the DC power source 101, which is arranged in the body, is constituted by a battery, or a rechargeable battery, to achieve continuous supply of a voltage. A main controller 200 is built in the above-described main printed circuit board, to receive a set temperature for the heat generating tip, and to control the display to display the temperature of the heat generating tip.

It is determined whether or not the finger of the user touches the touch switch 122, in accordance with an operation of the touch switch 122 to sense a variation in capacitance. When it is determined that the finger of the user has touched the touch plate, current is supplied to the heat generating tip through the synchronous type buck converter switching circuit 300 described with reference to FIGS. 9 and 10, thereby causing the heat generating tip to generate heat. Thus, a required operation can be performed. The temperature of the heat generating tip is checked in real time by the main controller, and is displayed on the display. Based on the checked temperature, the main controller controls the switching circuit such that the heat generating tip is maintained at the set temperature.

As apparent from the above description, in accordance with the present invention, a cordless gutta-percha filling instrument for endodontic treatment capable of using a miniature battery can be manufactured using a switching circuit which realizes a high efficiency.

In accordance with the present invention, control elements such as the display and operation condition setting button are completely installed on the body 110. Accordingly, the operator can concentrate upon an operation. It is also possible to conveniently carry the instrument.

In accordance with the present invention, it is also possible to control operation of the heat generating tip using the touch switch which is adapted to measure a variation in capacitance. Accordingly, malfunction of the filling instrument is prevented.

In addition, it is possible to illuminate the oral cavity, for which external illumination is difficult, using the light emitter arranged at the front end portion of the body. Accordingly, effective treatment can be achieved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A cordless endodontic filling instrument for back-filling comprising:
a body which has a pen shape, to enable an operator to easily grasp the body, includes a DC power source and a main printed circuit board which are arranged in the body;
a heat generating tip which extends forwardly from the body, and functions to heat and melt gutta-percha, and to fill a root canal with the melted gutta-percha; and
a touch switch which is arranged at a front portion of the body, to sense a variation in capacitance occurring when the operator touches the touch switch by the finger, and to turn on the heat generating tip based on the sensed capacitance variation.

2. The cordless endodontic filling instrument for back-filling as set forth in claim 1, wherein the heat generating tip includes:
a heat generating core which is arranged in an interior of the heat generating tip;
an insulating film which encloses the heat generating core; and
a conical resistant heat generating layer which encloses the insulating film, and has a cross-sectional area gradually reduced toward a front end of the heat generating core,
wherein the front end of the heat generating core is connected to the resistant heat generating layer.

3. The cordless endodontic filling instrument for back-filling as set forth in claim 2, wherein
the heat generating core includes a hollow pipe made of aluminum or aluminum alloy;
the insulating film is made of alumite; and
the resistant heat generating layer has a tin-sputtered outer surface.

4. The cordless endodontic filling instrument for back-filling as set forth in claim 3, wherein the resistant heat generating layer sputtered with tin has an inner surface on which nickel is sputtered in a predetermined region.

5. The cordless endodontic filling instrument for back-filling as set forth in claim 1, wherein the body further includes an operation condition setting button for setting an operation condition of the filling instrument, and a display for displaying an operation state of the filling instrument.

6. The cordless endodontic filling instrument for back-filling as set forth in claim 1, wherein the body further includes a light emitter arranged at a front end portion of the body, to illuminate an oral cavity.

7. The cordless endodontic filling instrument for back-filling as set forth in claim 6, wherein the light emitter includes a light emitting diode (LED).

8. The cordless endodontic filling instrument for back-filling as set forth in claim 1, wherein the touch switch includes:
a high-frequency generator;
a resistor connected to the high-frequency generator; and
a touch plate arranged to enclose a front end portion of the body where the finger of the operator will be positioned when the operator grasps the filling instrument.

9. The cordless endodontic filling instrument for back-filling as set forth in claim 1, wherein the switching circuit is a synchronous type buck converter switching circuit which includes two switches controlled to be alternately opened and closed, and an inductor and a resistor which are connected to one of the switches in series.

10. The cordless endodontic filling instrument for back-filling as set forth in claim 9, wherein the resistor of the switching circuit is the heat generating tip.

11. The cordless endodontic filling instrument for back-filling as set forth in claim 9, wherein the inductor of the switching circuit is arranged in a front end portion of the body near the heat generating tip.

12. The cordless endodontic filling instrument for back-filling as set forth in claim 1, wherein the DC power source of the body includes a rechargeable battery such that the DC power source is rechargeable after an operation.

13. The cordless endodontic filling instrument for back-filling as set forth in claim 1, wherein
the heat generating tip includes a heat generating core, an insulating film, and a resistant heat generating layer, the heat generating core being made of aluminum or aluminum alloy and including a hollow pipe; and
the insulator is made of alumite, and covers the heating generating core, except for a front end of the heat generating core, and the resistant heat generating layer has a tin-sputtered outer surface, and an inner surface on which nickel is sputtered in a predetermined region, to form a nickel film.
